(19) United States
(12) Patent Application Publication
(10) Pub. No.: US 2022/0044627 A1
(43) Pub. Date: Feb. 10, 2022

(54) PIXEL CIRCUIT, DRIVING METHOD THEREOF, AND DISPLAY PANEL

(71) Applicant: Wuhan China Star Optoelectronics Semiconductor Display Technology Co., Ltd., Wuhan, Hubei (CN)

(72) Inventor: Yong CHEN, Wuhan, Hubei (CN)

(73) Assignee: Wuhan China Star Optoelectronics Semiconductor Display Technology Co., Ltd., Wuhan, Hubei (CN)

(21) Appl. No.: 16/760,041

(22) PCT Filed: Apr. 3, 2020
(86) PCT No.: PCT/CN2020/083158

§ 371 Date: Apr. 29, 2020

(30) Foreign Application Priority Data
Mar. 19, 2020 (CN) 202010194824.2

(51) Int. Cl. G09G 3/3208

(52) U.S. Cl. CPC G09G 3/3208; G09G 2330/02; G09G 2310/08; G09G 2300/0842

(57) ABSTRACT

A pixel circuit, a driving method thereof, and a display panel are provided. The pixel circuit includes a first thin film transistor, a second thin film transistor, a first storage capacitor, a second storage capacitor, and an organic light-emitting diode. By adding a storage capacitor to a two-thin film transistors one-capacitor (2T1C) pixel circuit and electrically connected to a control signal, and further lowing a gate voltage of a second thin film transistor. As a result, a current of the pixel circuit under a same data signal voltage is greatly increased.

### FIELD OF INVENTION

The present application relates to the field of display technologies, in particular to a pixel circuit, a driving method thereof, and a display panel.

### BACKGROUND OF INVENTION

With continuous development of science and technology, people have higher and higher requirements on display devices, and development of display screen technologies also have made rapid progress. Nowadays, full-screen design has become mainstream of the times, all screen suppliers are focusing on development of full-screen products with a relatively higher screen-to-body ratio, and increasing screen-to-body ratio has become a product development trend.

At present, many solutions for increasing the screen-to-body ratio in the market usually design a front camera on an outside of display screens, and a special-shaped cutting design make the display screens resized to accommodate the front camera. No matter how much the cutting design changes, it is far from a full-screen concept. The recently-emerged light-emitting type camera under panel (CUP) processing scheme can make the display screens almost close to a full-screen effect.

As shown in FIG. 1, which is a schematic structural diagram of a conventional under-screen camera display panel, an under-screen camera display panel 90 includes a flexible substrate layer 91, an array substrate 92, a light-emitting layer 93, an encapsulation layer 94, a polarizer 95, and a cover plate 96 stacked sequentially from bottom to top. A through hole is defined in a corresponding position of the array substrate 92 and the polarizer 95 to form a blind hole 97. A camera 98 is disposed under a screen, and is arranged corresponding to the blind hole 97, that is, a region where the blind hole 97 and the camera 98 are positioned is an under-screen camera region. Through optimization of panel design and lens design, a lens can be hidden under a displayable region of the screen to complete image capturing. In the under-screen camera solution, in order to improve transmittance of the under-screen camera region, when using a classic seven-thin film transistors one-capacitor (7T1C) circuit of organic light-emitting diode (OLED) display, in order to improve transmittance of the under-screen camera region, a pixel design needs to be optimized to reduce a pixel density of the under-screen camera region to achieve partial transparency.

Mounting a two-thin film transistors one-capacitor (2T1C) pixel circuit above the under-screen camera region can reduce the pixel density well because the camera region is smaller, and the 2T1C pixel circuit has a small impact on the display screens. However, a currently operation voltage of the 2T1C pixel circuit is not within a normal voltage range given by a driving circuit, so it is not desirable to carry a traditional 2T1C pixel circuit in the under-screen camera region.

In the under-screen camera technology, the most influential factor for imaging is transmittance of the screen. Therefore, improving transmittance of the under-screen camera region has become an urgent problem to be solved.

### SUMMARY OF INVENTION

### Technical Problem

An object of the present invention is to provide a pixel circuit, a driving method thereof, and a display panel. By changing a circuit structure corresponding to an under-screen camera region, effect of improving transmittance is achieved.

### Technical Solution

To achieve the above object, the present invention provides a pixel circuit, including: a first thin film transistor, a second thin film transistor, a first storage capacitor, a second storage capacitor, and an organic light-emitting diode; wherein a gate of the first thin film transistor is electrically connected to a scan signal, a source of the first thin film transistor is electrically connected to a data signal, a drain of the first thin film transistor is electrically connected to a gate of the second thin film transistor, a first end of the first storage capacitor, and a first end of the second storage capacitor; wherein a source of the second thin film transistor is electrically connected to a positive power supply voltage, and a drain of the second thin film transistor is electrically connected to an anode of the organic light-emitting diode; wherein a cathode of the organic light-emitting diode is electrically connected to a negative power supply voltage; wherein the first end of the first storage capacitor is electrically connected to the drain of the first thin film transistor, and a second end of the first storage capacitor is electrically connected to the source of the second thin film transistor; and wherein the first end of the second storage capacitor is electrically connected to the drain of the first thin film transistor, and the second end of the second storage capacitor is electrically connected to a control signal.

Furthermore, a capacitance value of the second storage capacitor is 1/7 of a capacitance value of the first storage capacitor.

Furthermore, each of the first thin film transistor and the second thin film transistor is any one of a low temperature polysilicon thin film transistor, an oxide semiconductor thin film transistor, and an amorphous silicon thin film transistor.

Furthermore, the control signal is provided by an external timing controller.

Furthermore, the first thin film transistor provides a constant driving current for the organic light-emitting diode.

In order to achieve the above object, the present invention also provides a driving method, including following steps: the scan signal controlling the first thin film transistor to turn on; the data signal entering the gate of the second thin film transistor, the first storage capacitor, and the second storage capacitor through the first thin film transistor; and then turning off the first thin film transistor; wherein due to storage function of the first storage capacitor and the second storage capacitor, a gate voltage of the second thin film transistor still maintains a data signal voltage, so that the second thin film transistor is in a conductive state, and a driving current enters the organic light-emitting diode through the second thin film transistor to drive the organic light-emitting diode to emit light.

Furthermore, the gate voltage of the second thin film transistor is lower than a threshold voltage of the second thin film transistor.

The present invention also provides a display panel including the pixel circuit as described above.

Furthermore, the display panel includes an under-screen camera region and a display region arranged around the under-screen camera region, and the pixel circuit is arranged in the under-screen camera region.

### Beneficial Effect

Technical effect of the present invention is to provide a pixel circuit, a driving method thereof, and a display panel. By adding a storage capacitor to a two-thin film transistors one-capacitor (2T1C) pixel circuit and electrically connected to a control signal, and further lowing a gate voltage of a second thin film transistor. As a result, a current of the pixel circuit under a same data signal voltage is greatly increased, and setting the pixel circuit in an under-screen camera region can reduce a pixel density and improve transmittance of the under-screen camera region.

### BRIEF DESCRIPTION OF FIGURES

The technical solutions and other beneficial effects of the present application will be apparent through detailed description of specific embodiment of the present application in conjunction with the accompanying drawings.

FIG. 1 is a schematic structural diagram of a conventional under-screen camera display panel.

FIG. 2 is a schematic structural diagram of a two-thin film transistors one-capacitor (2T1C) pixel circuit.

FIG. 3 is a sequence diagram of a scan signal (Scan) in the 2T1C pixel circuit shown in FIG. 2.

FIG. 4 is a simulation diagram of the 2T1C pixel circuit shown in FIG. 2.

FIG. 5 is a schematic structural diagram of a seven-thin film transistors one-capacitor (7T1C) pixel circuit.

FIG. 6 is a sequence diagram of the 7T1C pixel circuit shown in FIG. 5.

FIG. 7 is a simulation diagram of the 7T1C pixel circuit shown in FIG. 5.

FIG. 8 is a schematic structural diagram of a two-thin film transistors two-capacitors (2T2C) pixel circuit according to an embodiment of the present invention.

FIG. 9 is a partial schematic view of a display panel according to an embodiment of the present invention.

FIG. 10 is a sequence diagram of the 2T2C pixel circuit shown in FIG. 8.

FIG. 11 is a simulation diagram of the 2T2C pixel circuit shown in FIG. 8.

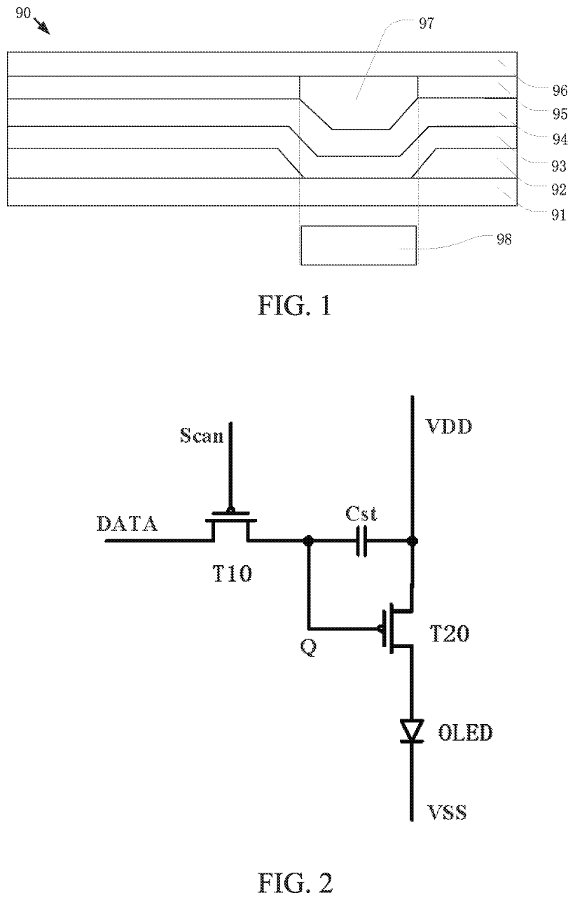

### DETAILED DESCRIPTION OF EMBODIMENTS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

In the description of this application, it should be noted that the terms “installation”, “connected”, and “coupled” should be understood in a broad sense, unless explicitly stated and limited otherwise. For example, they may be fixed connections, removable connected or integrally connected; it can be mechanical, electrical, or can communicate with each other; it can be directly connected, or it can be indirectly connected through an intermediate medium, it can be an internal communication of two elements or an interaction relationship of two elements. For those of ordinary skill in the art, the specific meanings of the above terms in this application can be understood according to specific situations.

FIG. 2 is a schematic structural diagram of a two-thin film transistors one-capacitor (2T1C) pixel circuit. The 2T1C pixel circuit includes a first thin film transistor T10, a second thin film transistor T20, a storage capacitor Cst, and an organic light-emitting diode (OLED).

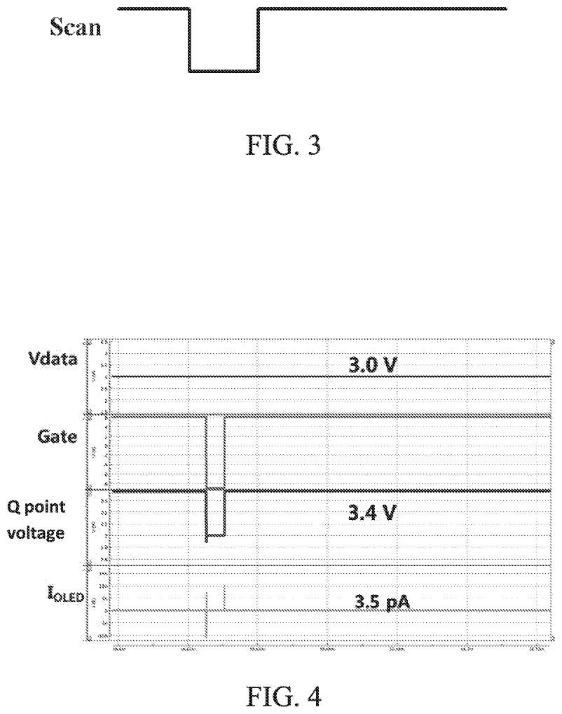

A gate of the first thin film transistor T10 is electrically connected to a scan signal Scan. A sequence diagram of the scan signal Scan is shown in FIG. 3. A source of the first thin film transistor T10 is electrically connected to a data signal Data, and a drain of the first thin film transistor is electrically connected to a gate of the second thin film transistor T20 and an end of the storage capacitor Cst. A drain of the second thin film transistor T20 is electrically connected to a positive power supply voltage VDD, and a source of the second thin film transistor is electrically connected to an anode of the organic light-emitting diode OLED. A cathode of the organic light-emitting diode OLED is electrically connected to a negative power supply voltage VSS. The end of the storage capacitor Cst is electrically connected to the drain of the first thin film transistor T10, and another end is electrically connected to the source of the second thin film transistor T20.

During display, the scan signal Scan controls the first thin film transistor T10 to turn on, a data signal Data enters the gate of the second thin film transistor T20 and the storage capacitor Cst through the first thin film transistor T10, and then the first thin film transistor T10 is turned off. Due to storage function of the storage capacitor Cst, a gate voltage of the second thin film transistor T20 still maintains a voltage of the data signal, so that the second thin film transistor T20 is in a conductive state, and a driving current enters the organic light-emitting diode OLED through the second thin film transistor T20 to drive the organic light-emitting diode OLED to emit light.

The 2T1C pixel circuit does not capture a threshold voltage Vth, keeping sizes of the thin film transistors and the storage capacitor consistent with the classic seven-thin film transistors one-capacitor (7T1C). When the data signal voltage Data written by the first thin film transistor T10 is 3.0V, according to simulation results of FIG. 4, a Q point voltage of a gate of the second thin film transistor T20 will reach 3.4V due to connection with the drain of the first thin film transistor T10, so there is no threshold voltage Vth capture of the 7T1C pixel circuit. When a voltage writing for the positive power supply voltage VDD is 4.6V, and a voltage writing for the negative power supply voltage VSS is −4.0V, for p-type thin film transistor (TFT), a gate voltage Vgs=3.4-4.6=−1.2V, which is greater than a threshold voltage Vth of the second thin film transistor T20 (about −2.5 V). The second thin film transistor T20 is not turned on, and theoretically a current flowing through the organic light-emitting diode is almost 0, which is close to a simulation result of IOLED=3.5 pA shown in FIG. 4.

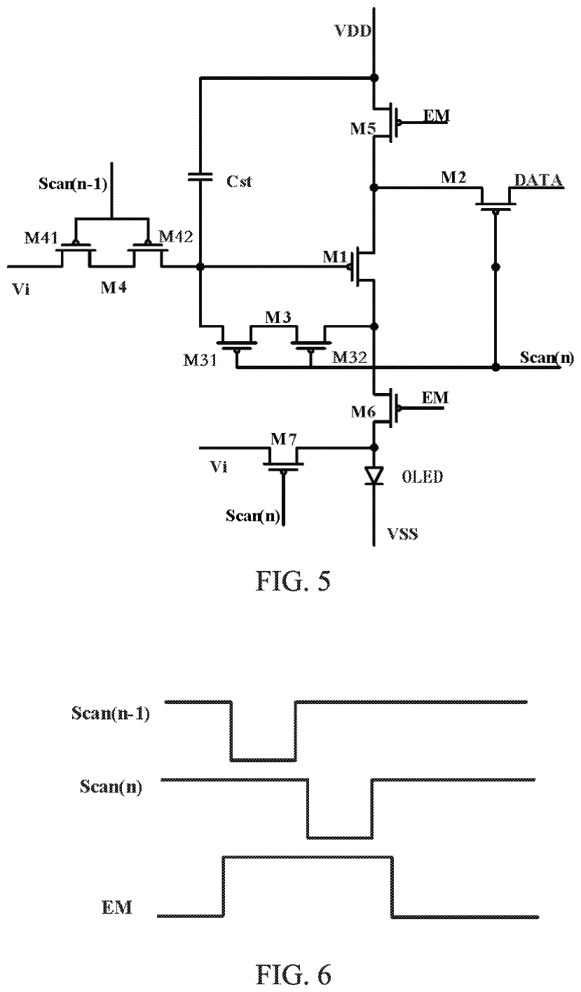

As shown in FIG. 5, which is a schematic structural diagram of a 7T1C pixel circuit, the 7T1C pixel circuit includes a first transistor M1, a second transistor M2, a third transistor M3, a fourth transistor M4, a fifth transistor M5, a sixth transistor M6, a seventh transistor M7, a storage capacitor Cst, and an organic light-emitting diode OLED.

A gate of the first transistor M1 is connected to a first end of the storage capacitor Cst, a first electrode of the first transistor M1 is connected to a first electrode of the second transistor M2, and a second electrode of the first transistor M1 is connected to a first electrode of the third transistor M3. A gate of the second transistor M2 is connected to a second scan signal terminal Scan (n), and a second electrode of the second transistor M2 is connected to a data signal terminal Vdata. A gate of the third transistor M3 is connected to the second scan signal terminal Scan (n), and a second electrode of the third transistor M3 is connected to the first end of the storage capacitor Cst. A second end of the storage capacitor Cst is connected to a first voltage signal terminal VDD.

A gate of the fourth transistor M4 is connected to a first scan signal terminal Scan (n−1), a first electrode of the fourth transistor M4 is connected to the first end of the storage capacitor Cst, and a second electrode of the fourth transistor M4 is connected to an initialization signal terminal Vi. A gate of the fifth transistor M5 is connected to a control signal terminal EM, a first electrode of the fifth transistor M5 is connected to the first voltage signal terminal VDD, and a second electrode of the fifth transistor M5 is connected to the first electrode of the first transistor M1. A gate of the sixth transistor M6 is connected to the control signal terminal EM, a first electrode of the sixth transistor M6 is connected to the second electrode of the first transistor M1, and a second electrode of the sixth transistor M6 is connected to an anode of the organic light-emitting diode OLED. A cathode of the organic light-emitting diode OLED is connected to a second voltage signal terminal VSS.

A gate of the seventh transistor M7 is connected to the second scan signal terminal Scan (n), a first electrode of the seventh transistor M7 is connected to the initialization signal terminal Vi, and a second electrode of the seventh transistor M7 is connected to the anode of the organic light-emitting diode OLED.

The third transistor M3 includes two sub-transistors connected in series, a gate of a first sub-transistor M31 is connected to the second scan signal terminal Scan (n), a first electrode of the first sub-transistor M31 is connected to a second electrode of a second sub-transistor M32, a second electrode of the first sub-transistor M31 is connected to the first end of the storage capacitor Cst, a gate of the second sub-transistor M32 is connected to the second scan signal terminal Scan (n), and a first electrode of the second sub-transistor M32 is connected to the second electrode of the first transistor M1.

The fourth transistor M4 includes two sub-transistors connected in series, a gate of a third sub-transistor M41 is connected to the first scan signal terminal Scan (n−1), a first electrode of the third sub-transistor M41 is connected to the first end of the storage capacitor Cst, a second electrode of the third sub-transistor M41 is connected to a first electrode of a fourth sub-transistor M42, a gate of the fourth sub-transistor M42 is connected to the first scan signal terminal Scan (n−1), and a second electrode of the fourth sub-transistor M42 is connected to the initialization signal terminal Vi.

The first end of the storage capacitor Cst, the gate of the first transistor M1, the second electrode of the third transistor M3, and the first electrode of the fourth transistor M4 are electrically connected to each other.

A sequence diagram of the 7T1C pixel circuit is shown in FIG. 6. In an initialization phase, the first scan signal terminal Scan (n−1) provides a low-level signal, the fourth transistor M4 is turned on, and the initialization signal Vi initializes the storage capacitor Cst through the fourth transistor M4. In a data writing phase, the second scan signal terminal Scan (n) provides a low-level signal, the second transistor M2 and the third transistor M3 are turned on, and a signal provided by the data signal terminal Vdata is charged the first end of the storage capacitor until the first transistor M1 is turned off. A conventional thin film transistor size and storage capacitor size are maintained in the 7T1C pixel circuit.

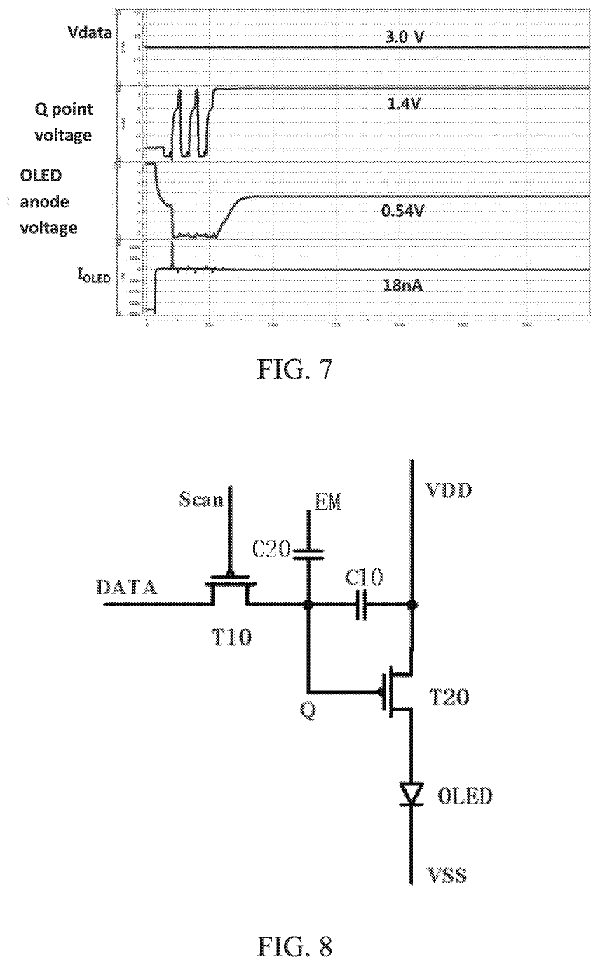

A simulation result is shown in FIG. 7. When a voltage writing for the data signal Data is 3.0V, a gate voltage of the first transistor M1 reaches 1.4V due to its threshold voltage Vth capture, a voltage writing for the positive power supply voltage VDD is 4.6V and a voltage writing for a negative power supply voltage VSS is −4.0V, for p-type TFT, the gate voltage Vgs=1.4-4.6=−3.2V at this time, which is less than a threshold voltage Vth (about −2.5V) of the first transistor M1, the first transistor M1 is in a conductive state, and a current flowing through the organic light-emitting diode OLED is 18 nA according to a simulation result.

Under a same voltage writing for the data signal Data, the current flowing through the organic light-emitting diode OLED in the 2T1C pixel circuit differs from the current flowing through the organic light-emitting diode OLED in the 7T1C pixel circuit by at least 3 orders of magnitude, that is, for the 2T1C pixel circuit, to achieve the same current value as the 7T1C pixel circuit, a smaller voltage for the data signal Data need to be written. Generally, an operation voltage range of the data signal Data of the 7T1C pixel circuit is about 3.0V-6.0V, and an operation voltage range of the data signal Data of a corresponding 2T1C pixel circuit is about 0.5V-3.5V. The operating voltage of the 2T1C pixel circuit is not within a normal voltage range given by a driving circuit, so it is not advisable to carry the 2T1C pixel circuit in the under-screen camera region.

In response to the above technical problems, the applicant has provided a pixel circuit and a display panel through research, and introduced a capacitor on a 2T1C pixel circuit to improve transmittance.

FIG. 8 is a schematic structural diagram of a 2T2C pixel circuit according to an embodiment of the present application. The 2T2C pixel circuit includes a first thin film transistor T10, a second thin film transistor T20, a first storage capacitor C10, a second storage capacitor C20, and an organic light-emitting diode OLED.

A gate of the first thin film transistor T10 is electrically connected to a scan signal Scan, a source of the first thin film transistor T10 is electrically connected to a data signal Data, and a drain of the first thin film transistor is electrically connected to a gate of the second thin film transistor T20, a first end of the first storage capacitor C10, and a first end of the second storage capacitor C20. A source of the second thin film transistor T20 is electrically connected to a positive power supply voltage VDD, and a drain of the second thin film transistor is electrically connected to an anode of the organic light-emitting diode OLED. A cathode of the organic light-emitting diode OLED is electrically connected to a negative power supply voltage VSS. The first end of the first storage capacitor C10 is electrically connected to the drain of the first thin film transistor T10, and a second end of the first storage capacitor is electrically connected to the source of the second thin film transistor T20. The first end of the second storage capacitor C20 is electrically connected to the drain of the first thin film transistor T10, and the second end of the second storage capacitor is electrically connected to a control signal EM.

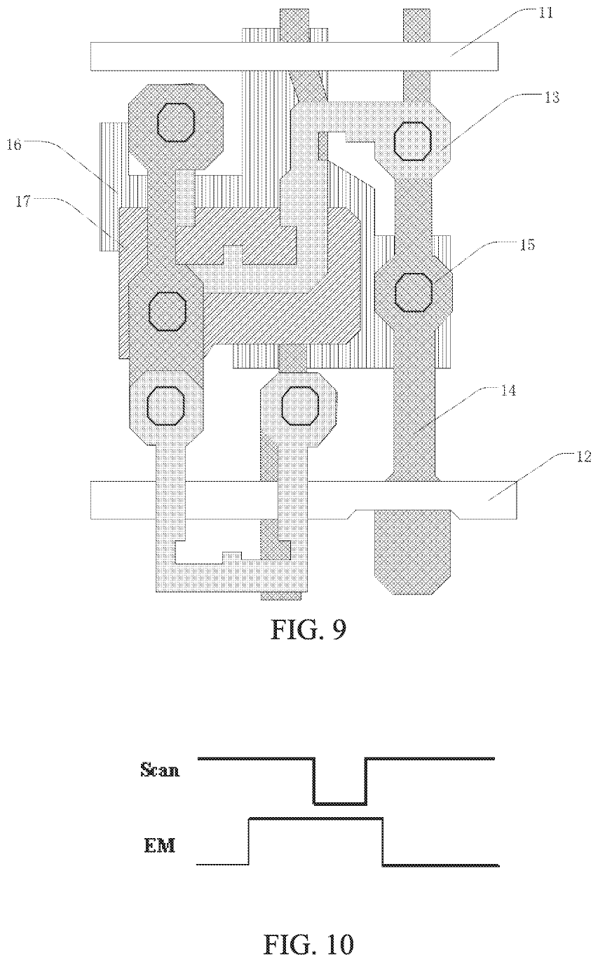

FIG. 9 is a partial schematic view of a structure of the display panel, which includes a control signal EM11, a scan signal Scan12, an active layer 13, a source-drain layer 14, a capacitor 15, a first gate layer 16, and a second gate layer 17.

A sequence diagram of the scan signal Scan and the control signal EM is shown in FIG. 10. During display, the scan signal Scan controls the first thin film transistor T10 to turn on, a data signal Data enters the gate of the second thin film transistor T20, the first storage capacitor C10, and the second storage capacitor C20 through the first thin film transistor T10, and then the first thin film transistor T10 is turned off. Due to storage function of the first storage capacitor C10 and the second storage capacitor C20, a gate voltage of the second thin film transistor T20 still maintains a voltage of the data signal, so that the second thin film transistor T20 is in a conductive state, and a driving current enters the organic light-emitting diode OLED through the second thin film transistor T20 to drive the organic light-emitting diode OLED to emit light.

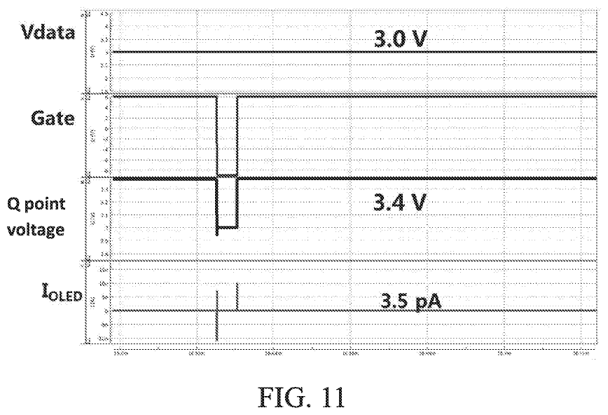

When a voltage of the data signal Data written by the first thin film transistor T10 is 3.0V, the second storage capacitor C20 is introduced to the gate of the second thin film transistor T20, and the second storage capacitor C20 is 10 fF (about 1/7 of a capacitance value of the first storage capacitor C10). In the meantime, according to simulation result as shown in FIG. 11, due to a Q point voltage of a gate of the second thin film transistor T20 is connected to the first end of the second storage capacitor C20, the control signal EM lowers the Q point voltage to 1.7V, a voltage writing for a positive power supply voltage VDD is 4.6V and a voltage writing for a negative power supply voltage VSS is −4.0V, for p-type TFT, the gate voltage Vgs of the second thin film transistor T20=1.7−4.6=−2.9V at this time, which is less than a threshold voltage Vth (about −2.5V) of the second transistor T20, the second thin film transistor T20 is in a conductive state, from simulation results in FIG. 10, a current flowing through the organic light-emitting diode OLED is IOLED=12.5 nA, which is at a same order of magnitude as a current flowing through the organic light-emitting diode OLED of the 7T1C pixel circuit, that is, a voltage difference between an improved 2T2C pixel circuit and a 7T1C pixel circuit for reaching a same current range is not big.

An embodiment of the present application also provides a display panel, including the 2T2C pixel circuit described in above embodiment.

The display panel includes an under-screen camera region and a display region arranged around the under-screen camera region, and the 2T2C pixel circuit is arranged in the under-screen camera region.

The technical effect of the present invention is to provide a pixel circuit, a driving method thereof, and a display panel. By adding a storage capacitor to a two-thin film transistors one-capacitor (2T1C) pixel circuit and electrically connected to a control signal, and further lowing a gate voltage of a second thin film transistor. As a result, current of the pixel circuit under a same data signal voltage is greatly increased, and setting the pixel circuit in an under-screen camera region can reduce a pixel density and improve transmittance of the under-screen camera region.

In the above embodiments, the description of each embodiment has its own emphasis. For a part that is not detailed in an embodiment, you can refer to the related descriptions of other embodiments.

A pixel circuit, a driving method thereof, and a display panel provided in the embodiments of the present application has been described in detail above. Specific embodiments have been used in this document to explain the principle and implementation of the present application. The descriptions of the above embodiments are only used to help understand the technical solution of the present application and its core ideas. A person skilled in the art can make various modifications and changes to the above embodiments without departing from the technical idea of the present invention, and such variations and modifications are intended to be within the scope of the invention.

What is claimed is:

1. A pixel circuit, comprising: a first thin film transistor, a second thin film transistor, a first storage capacitor, a second storage capacitor, and an organic light-emitting diode;
wherein a gate of the first thin film transistor is electrically connected to a scan signal, a source of the first thin film transistor is electrically connected to a data signal, a drain of the first thin film transistor is electrically connected to a gate of the second thin film transistor, a first end of the first storage capacitor, and a first end of the second storage capacitor;
wherein a source of the second thin film transistor is electrically connected to a positive power supply voltage, and a drain of the second thin film transistor is electrically connected to an anode of the organic light-emitting diode;
wherein a cathode of the organic light-emitting diode is electrically connected to a negative power supply voltage;
wherein the first end of the first storage capacitor is electrically connected to the drain of the first thin film transistor, and a second end of the first storage capacitor is electrically connected to the source of the second thin film transistor; and
wherein the first end of the second storage capacitor is electrically connected to the drain of the first thin film transistor, and the second end of the second storage capacitor is electrically connected to a control signal.

2. The pixel circuit according to claim 1, wherein a capacitance value of the second storage capacitor is 1/7 of a capacitance value of the first storage capacitor.

3. The pixel circuit according to claim 1, wherein each of the first thin film transistor and the second thin film transistor is any one of a low temperature polysilicon thin film transistor, an oxide semiconductor thin film transistor, and an amorphous silicon thin film transistor.

4. The pixel circuit according to claim 1, wherein the control signal is provided by an external timing controller.

5. The pixel circuit according to claim 1, wherein the first thin film transistor provides a constant driving current for the organic light-emitting diode.

6. A driving method used to drive the pixel circuit according to claim 1, wherein the driving method comprises following steps:
the scan signal controlling the first thin film transistor to turn on;
the data signal entering the gate of the second thin film transistor, the first storage capacitor, and the second storage capacitor through the first thin film transistor; and
then turning off the first thin film transistor;
wherein due to storage function of the first storage capacitor and the second storage capacitor, a gate voltage of the second thin film transistor still maintains a data signal voltage, so that the second thin film transistor is in a conductive state, and a driving current enters the organic light-emitting diode through the second thin film transistor to drive the organic light-emitting diode to emit light.

7. The driving method according to claim 6, wherein the gate voltage of the second thin film transistor is lower than a threshold voltage of the second thin film transistor.

8. The driving method according to claim 6, wherein the control signal is provided by an external timing controller.

9. The driving method according to claim 6, wherein a capacitance value of the second storage capacitor is 1/7 of a capacitance value of the first storage capacitor.

10. The driving method according to claim 6, wherein each of the first thin film transistor and the second thin film transistor is any one of a low temperature polysilicon thin film transistor, an oxide semiconductor thin film transistor, and an amorphous silicon thin film transistor.

11. The driving method according to claim 6, wherein the control signal is provided by an external timing controller.

12. The driving method according to claim 6, wherein the first thin film transistor provides a constant driving current for the organic light-emitting diode.

13. A display panel, comprising the pixel circuit according to claim 1.

14. The display panel according to claim 13, wherein the display panel comprises an under-screen camera region and a display region arranged around the under-screen camera region, and the pixel circuit is arranged in the under-screen camera region.

15. The display panel according to claim 14, wherein a capacitance value of the second storage capacitor is 1/7 of a capacitance value of the first storage capacitor.

16. The display panel according to claim 14, wherein each of the first thin film transistor and the second thin film transistor is any one of a low temperature polysilicon thin film transistor, an oxide semiconductor thin film transistor, and an amorphous silicon thin film transistor.

17. The display panel according to claim 14, wherein the control signal is provided by an external timing controller.

18. The display panel according to claim 14, wherein the first thin film transistor provides a constant driving current for the organic light-emitting diode.
